(19) United States
(12) Patent Application Publication
(10) Pub. No.: US 2026/0177318 A1
(43) Pub. Date: Jun. 25, 2026

(54) TUNNEL KILN FOR THE HEAT TREATMENT OF PRODUCTS, A METHOD FOR OPERATING SUCH A TUNNEL KILN AND THE USE OF SUCH A TUNNEL KILN

(71) Applicant: Riedhammer GmbH, Nurnberg (DE)

(72) Inventors: Andreas Hajduk, Nurnberg (DE); Rainer Gundel, Erlangen (DE); Andreas Overhoff, Langensendelbach (DE); Matthias Uhl, Sugenheim/Ullstadt (DE)

(73) Assignee: Riedhammer GmbH, Nurnberg (DE)

(21) Appl. No.: 18/729,213

(22) PCT Filed: Dec. 6, 2023
(86) PCT No.: PCT/EP2023/084587

§ 371 Date: Jul. 16, 2024

(30) Foreign Application Priority Data
Feb. 21, 2023 (CN) 202310143830.9

(51) Int. Cl. F27B 9/26; B22F 1/142; F27B 9/30

(52) U.S. Cl. CPC F27B 9/262; F27B 9/3011; B22F 1/142; F27B 2009/3016

(57) ABSTRACT

The invention relates to a tunnel kiln for the heat treatment of products, a method for operating such a tunnel kiln and the use of such a tunnel kiln.

### FIELD OF THE INVENTION

The invention relates to a tunnel kiln for the heat treatment of products, a method for operating such a tunnel kiln and the use of such a tunnel kiln.

### BACKGROUND OF THE INVENTION

A tunnel kiln, also known as a continuous kiln, is a continuous kiln type, i.e., an industrial kiln that is continuously charged with products to be treated with heat in the kiln. For this purpose, a tunnel kiln has a tunnel-like kiln chamber through which the products to be treated with heat are continuously moved and thereby exposed to heat. The tunnel-like kiln chamber extends from a first end, at which the products are introduced into the kiln chamber, to an opposite second end, at which the products are removed from the kiln chamber again after their heat treatment in the kiln chamber. Tunnel kilns are usually operated according to the counterflow principle. Fresh air is introduced into the kiln chamber at the second end, which is also referred to as the kiln outlet, then passed through the kiln chamber and discharged from the kiln chamber at the first end, which is also referred to as the kiln inlet. Means for heating the kiln chamber, usually in the form of gas burners, are arranged in the central area of the kiln chamber, which is also referred to as the firing zone. The fresh air introduced into the kiln chamber at the second end is therefore initially relatively cool, is heated in the firing zone and this hot firing gas is then conveyed to the first end of the kiln chamber, where it is discharged from the kiln. Products transported through the kiln chamber are therefore first preheated by the heated firing gases, thermally treated in the firing chamber by the hot gases and then indirectly cooled by a heat exchanger before leaving the kiln chamber. These three zones of the kiln chamber of a tunnel kiln are therefore also referred to as the heating zone, holding zone and cooling zone. In order to reduce temperature losses at the kiln inlet and kiln outlet, it is known to make the kiln inlet and kiln outlet closable by means of closing devices, for example in the form of airlocks.

Rail-guided kiln cars are known for transporting the products through the kiln chamber. These kiln cars are usually moved by wire rope hoists or other mechanical drive means.

In principle, such tunnel kilns have proven themselves for the heat treatment of products. However, the heat treatment of products in powder form in such tunnel kilns poses a challenge. This is because the gas flows of the firing gases in the kiln chamber in conventional tunnel kilns can cause undesirable turbulence in the powdered products. At the same time, unwanted contamination of the powdered products can occur.

It is an object of the invention to provide a tunnel kiln for the heat treatment of products, which can also be used in an advantageous manner, in particular for the heat treatment of powdered products. In particular, it is an object of the invention to provide a tunnel kiln for the heat treatment of powdered products, in which turbulence and contamination of the powdered products during heat treatment in the tunnel kiln can be avoided.

Furthermore, it is an object of the invention to provide a method for operating such a tunnel kiln.

### SUMMARY OF THE INVENTION

To solve the above objects, a tunnel kiln for heat treatment of products is provided, comprising the following features:

Tunnel kiln for heat treatment of products, comprising the following features:
a tunnel-like kiln chamber which extends from a first end to a second end of the kiln chamber, the kiln chamber being limited on the upper side by a kiln ceiling and on the side by kiln walls;
kiln cars which can be moved from the first end to the second end along a transport direction through the kiln chamber and on which products to be treated with heat in the kiln chamber can be transported;
kiln furniture for holding the products, the kiln furniture being arranged on the kiln cars;
gas outlets, via which the gas present in the kiln chamber can be discharged from the kiln chamber;
gas inlets, via which gas can be introduced into the kiln chamber;
at least one blower, via which gas can be conducted to the gas inlets; and
means for heating the kiln chamber; wherein
gas located in the region of the kiln ceiling can be discharged from the kiln chamber via the gas outlets;
gas in the region of the kiln walls can be introduced into the kiln chamber via the gas inlets; wherein
the kiln furniture is arranged on the kiln cars with the formation of at least one vertical gap between the kiln furniture; and wherein
the at least one blower has a coating made of a nickel-based alloy.

The provision of the tunnel kiln according to the invention is based, on the one hand, in particular on the finding according to the invention that turbulence of powdery products is caused in particular by horizontal flows of the gases in the kiln chamber in the region of the powders to be treated with heat in the tunnel kiln. In accordance with the invention, it was further recognized that these horizontal gas flows are caused in particular by the gas flow along the longitudinal axis of the kiln chamber, i.e., along the direction of transport of the kiln cars in the tunnel kilns commonly operated according to the counterflow principle in the prior art. One basic idea of the invention is therefore to avoid horizontal gas flows in the kiln chamber, particularly in the area of the products to be fired. In this respect, a central idea of the invention is to generate an essentially vertically upwardly directed gas flow in the area of the products to be fired. In particular, this also means a departure from the usual counterflow principle when operating the tunnel kiln according to the invention. The gas outlets and gas inlets of the tunnel kiln according to the invention are provided in order to enable a vertically upwardly directed gas flow during operation of the tunnel kiln according to the invention. These gas outlets or gas inlets specifically arranged according to the invention enable a substantially vertically upward flow of the combustion gases in the kiln chamber. Furthermore, these gas outlets and gas inlets are synergistically supplemented by the specific arrangement of the kiln furniture, which is arranged on the kiln cars, forming a vertical gap between the kiln furniture. According to the invention, it was recognized that by forming such vertical gaps between the kiln furniture, a vertically upwardly directed gas flow can be generated or supported in the kiln chamber.

The provision of the tunnel kiln according to the invention is furthermore based in particular on the realization according to the invention that contamination of powdery products can be caused in particular by parts of the blower via which gas can be conducted to the gas inlets. According to the invention, it was recognized that this can be due in particular to a lack of chemical and thermal resistance of components of the blower. Surprisingly, it has been found according to the invention that such contamination by the blower can be prevented if parts or components of the blower have a coating of a nickel-based alloy.

The tunnel kiln according to the invention is used in particular for the heat treatment of products in the form of powder. The tunnel kiln according to the invention has proved to be particularly advantageous for the heat treatment of products in the form of cathode material, in particular such cathode material in powder form. In particular, the tunnel kiln according to the invention has proved to be particularly advantageous for synthesizing such cathode material in powder form.

The kiln chamber of the tunnel kiln according to the invention can be designed essentially in accordance with the prior art. In this respect, the kiln ceiling can be designed as known from the prior art, preferably as a flat ceiling or vaulted ceiling, but preferably as a vaulted ceiling. Preferably, the kiln ceiling can include refractory bricks, in particular refractory ceramic bricks, particularly preferably bricks based on Al₂O₃, in particular bricks with a content of Al₂O₃ of at least 97% by mass, even more preferably of at least 99% by mass, based on the mass of the bricks.

The gas outlets in the kiln ceiling can be provided in particular in the form of openings in the kiln ceiling. Preferably, several gas outlets are provided, preferably distributed over the kiln ceiling, particularly preferably evenly distributed over the kiln ceiling, especially over the length of the kiln. In this way, a very uniform upward vertical flow of gases in the kiln chamber can be achieved. According to a preferred embodiment, the gas outlets are arranged in the middle of the kiln ceiling. If the kiln ceiling is designed as a vault, the outlets are preferably arranged at the apex of the vault, with the apex of the vault preferably running in the middle of the kiln ceiling.

The gas outlets preferably open into gas lines through which the gas that can be discharged from the gas outlets can be conducted.

According to the invention, at least one blower is provided, via which the gas can be conducted to the gas inlets. Preferably, the gas can be conducted from the at least one blower to the gas inlets via gas lines.

As explained above, the at least one blower according to the invention has a coating of a nickel-based alloy in order to prevent products treated in the tunnel kiln according to the invention, in particular in the form of powder, from being contaminated by parts of the blower. According to the invention, it has been recognized that the products can be contaminated in particular by moving parts of the blower. In this respect, it may preferably be provided that at least moving parts of the at least one blower have a coating of a nickel-based alloy.

Preferably, the at least one blower is in the form of at least one fan. As is known, a fan comprises an impeller through which gas flows and which usually rotates in a housing. According to the invention, it can now preferably be provided that the impeller has a coating of a nickel-based alloy.

According to a preferred embodiment, a nickel-based alloy is provided which is suitable for application temperatures above 1,000° C., in particular for application temperatures above 1,100° C.

According to a preferred embodiment, the nickel-based alloy can be in the form of one of the following nickel-based alloys: Nickel-aluminum alloys, nickel-molybdenum alloys, nickel-tungsten carbide alloys or low-alloy nickel alloys.

The nickel-based alloy can comprise a proportion of nickel (Ni) in the range from 30 to 99.5%, more preferably in the range from 60 to 99.5% and particularly preferably in the range from 60 to 90%.

All figures given herein in % are given in % by mass and in relation to the total mass of the nickel-based alloy. The proportions of the alloy components of the nickel-based alloy in % indicate the chemical composition of the nickel-based alloy.

According to one embodiment, the nickel-based alloy comprises at least one of the following components in addition to nickel: Al (aluminum), Mo (molybdenum), WC (tungsten carbide), copper (Cu), titanium (Ti) or chromium (Cr).

According to one embodiment, it is provided that the nickel-based alloy comprises a total proportion of Al, Mo, WC, Cu, Ti and Cr in the range of 0.5-70%, further preferably in the range of 0.5-40% and particularly preferably in the range of 10-40%. At the same time, it may preferably be provided that the nickel-based alloy comprises the above-mentioned proportions of nickel.

According to one embodiment, the nickel-based alloy comprises a proportion of Al in the range of 0.5-20.0% and Ni in the range of 80.0-99.5%.

According to one embodiment, the nickel-based alloy comprises a proportion of Mo in the range of 0.5-20.0% and Ni in the range of 80.0-99.5%.

According to one embodiment, the nickel-based alloy comprises a proportion of WC in the range of 0.5-60.0% and Ni in the range of 40.0-99.5%.

In addition to the aforementioned alloy components, the nickel-based alloy can generally comprise one or more of the other known alloy components for nickel-based alloys.

According to the invention, it is preferably provided that the coating has a thickness in the range from 0.1 mm to 1.5 mm. According to the invention, it has been found that if the coating is less than 0.1 mm thick, there is a risk of kiln gases coming into contact with the coated areas of the blower during the firing process in the tunnel kiln, which could contaminate the material to be fired. It has also been found that if the coating is thicker than 1.5 mm, thermal stresses can occur in the coating, which can lead to damage to the coating. It is further preferred that the coating has a thickness in the range from 0.2 to 1.0 mm, even more preferably in the range from 0.4 to 0.8 mm and even more preferably in the range from 0.5 to 0.6 mm.

Generally, the at least one blower can be coated with the nickel-based alloy according to the invention using any of the technologies known from the prior art. Preferably, the coating can be applied by at least one of the following processes: thermal spraying or baking. As is known, thermal spraying is a technology in which the material forming the subsequent coating, in the present case a nickel-based alloy, is first melted and then sprayed in a gas stream onto the surface to be coated, in the present case the parts of the fan to be coated. According to a preferred embodiment of thermal spraying, the nickel-based alloy is applied by flame spraying, even more preferably by wire flame spraying.

As is known, during baking, the material to be coated, i.e., a nickel-based alloy according to the invention, is first applied in powder form or as an emulsion to the surface to be coated, in this case the parts of the fan to be coated, and then baked in an inert atmosphere.

The at least one fan is preferably provided completely or partially outside the kiln chamber.

According to one embodiment, it is provided that the gas that can be discharged from the gas outlets can be extracted by the at least one blower and, in particular, passed on via the gas lines. If the blowers are partially arranged outside the kiln chamber, the blowers can have an intake nozzle, which can also extend into the kiln chamber into which the gas outlets open, for example. Preferably, the gas lines for conducting the gas that can be discharged from the gas outlets lead to at least one of the blowers in each case and, particularly preferably, lead to at least one of these intake nozzles.

According to a preferred embodiment, the gas that can be discharged from the gas outlets can be fed to an intake nozzle of the at least one blower. According to a particularly preferred embodiment of this inventive concept, the intake nozzle has the coating of a nickel-based alloy. According to the invention, it was recognized that the intake nozzle in particular-without the coating according to the invention-can also lead to contamination of the powder to be treated in the tunnel kiln during operation of the tunnel kiln.

According to a particularly preferred embodiment, both the impeller and the intake nozzle of the at least one fan have a nickel-based alloy coating.

The kiln walls preferably run vertically and are preferably made of refractory bricks, in particular refractory ceramic bricks. Preferably, the kiln walls can include refractory bricks, in particular refractory ceramic bricks, particularly preferably bricks based on Al₂O₃, in particular bricks with an Al₂O₃ content of at least 97% by mass, even more preferably at least 99% by mass, based on the mass of the bricks.

The gas inlets are preferably provided in the form of openings in the kiln walls. Preferably, several gas inlets are provided, preferably distributed over the kiln walls, particularly preferably evenly distributed over the kiln walls. In this way, gas can be introduced very uniformly into the kiln chamber via the gas inlets, whereby turbulence of powdery products to be treated with heat in the kiln chamber can be avoided. Preferably, the gas inlets are spaced apart from each other along the transport direction, particularly preferably evenly distributed over the length of the kiln. In this way, gas can be introduced into the kiln chamber particularly evenly along the length of the kiln, which in turn avoids turbulence of powdery products in the kiln chamber.

If both the gas outlets and the gas inlets are distributed over the length of the kiln, in particular evenly distributed over the length of the kiln, a particularly uniform vertically upward gas flow can be generated in the kiln chamber.

According to one embodiment, the flow cross-section of the gas inlets is adjustable. This has the particular advantage that the flow volume and the flow distribution of the gas that can be introduced into the kiln chamber via these gas inlets can be adjusted.

According to a preferred embodiment, the gas inlets are arranged in such a way that gas can be introduced into the kiln chamber via the gas inlets below the kiln furniture. This has the particular advantage that the gas introduced into the kiln chamber via these gas inlets does not lead to any turbulence of powdery products in the kiln chamber. In order to be able to introduce gas into the kiln chamber below the kiln furniture, gas inlets are preferably arranged at the lower end of the kiln walls, i.e., in the area of the kiln walls adjacent to the kiln floor. Preferably, gas can be introduced horizontally into the kiln chamber via these gas inlets, so that direct exposure of the powdered products to the gas introduced into the kiln chamber from these gas inlets can be prevented, thereby preventing turbulence of these products.

According to one embodiment, it can be provided that gas can only be introduced into the kiln chamber via the gas inlets underneath the kiln furniture.

According to one embodiment, it is provided that gas can be introduced into the kiln chamber at different heights via the gas inlets, i.e., at different (vertical) heights of the kiln chamber. To achieve this, the gas inlets can be arranged at different heights on the kiln walls. A particular advantage of this embodiment is that gas can be introduced into the kiln chamber distributed over the height of the kiln chamber, whereby gas can be introduced very evenly into the kiln chamber, thereby preventing turbulence of powdery products in the kiln chamber. In this embodiment, gas can also be introduced into the kiln chamber via the gas inlets in the area or at the height of the products to be treated in the kiln chamber. In order to nevertheless be able to prevent a turbulence of powdery products in the kiln chamber, it can be provided in this embodiment that gas can also be introduced into the kiln chamber via gas inlets below the kiln furniture, whereby with regard to these gas inlets, through which gas can be introduced into the kiln chamber below the kiln furniture, gas can be introduced into the kiln chamber at a higher velocity than through the other gas inlets, in particular those other gas inlets through which gas can be introduced into the kiln chamber at the level of the products to be treated in the kiln chamber.

If gas can be introduced into the kiln chamber via the gas inlets below the kiln furniture, this gas can then flow vertically upwards and, in particular, also flow upwards through the vertical gaps formed between the kiln furniture to the kiln ceiling, where the gas is then discharged from the kiln chamber via the gas outlets. As a result, the products in the kiln furniture are essentially subjected to heat by the vertically upward firing gases. In particular, it can be provided that gas can be introduced into the kiln chamber via the gas inlets underneath all the kiln furniture. This has the particular advantage that all kiln furniture can be supplied with gas on the underside, which can then flow vertically upwards between all kiln furniture, so that all kiln furniture, i.e., across the entire width of the kiln chamber, can be uniformly supplied with gas, in particular by a vertically upwards directed gas flow.

A further advantage of gas that can be introduced into the kiln chamber below the kiln furniture is that the products located in the kiln furniture can be very advantageously thermally treated, as heat losses of the products located in the lower kiln furniture can also be compensated for.

If, as described above, further gas inlets are provided at the height of the kiln furniture, these can be provided in particular for supplying gas to the kiln furniture adjacent to the kiln wall.

Overall, the gas inlets and gas outlets can therefore be arranged in such a way that gas can be guided through the kiln chamber forming an upward flow, in particular a vertically upward flow.

Furthermore, as described above, the gas inlets and outlets can be arranged in such a way that gas can be fed through the kiln chamber while avoiding a horizontal flow.

In particular, as explained above, the gas inlets and the gas outlets can therefore be arranged in such a way that gas can be guided through the kiln chamber while avoiding a gas flow according to the counterflow principle.

In this respect, as explained above, the gas inlets and the gas outlets can be arranged in such a way that gas can be guided through the kiln chamber in the direction of transportation while avoiding a gas flow.

The gas inlets are preferably connected to gas lines which open into the gas inlets and via which the gas which can be introduced into the kiln chamber through the gas inlets can be conducted to the gas inlets. According to a particularly preferred embodiment, it is provided that the gas outlets open into the above-mentioned gas lines, via which this gas can in turn be conducted to the gas inlets. Gas can therefore be circulated through the tunnel kiln. As explained above, this gas circulation can take place by means of at least one blower. A particular advantage of using blowers is that they can contribute to a homogenization of the kiln gases extracted from the kiln chamber.

Of course, not all of the gases extracted from the kiln chamber via the gas outlets have to be reintroduced into the kiln chamber via the gas inlets and circulated accordingly. Rather, as is known from the prior art, some of the gases extracted from the kiln chamber can be continuously extracted from the kiln as exhaust gas and fresh gas can also be continuously introduced into the kiln. The gas conduit means known from the prior art can be provided for this purpose.

In order to heat treat the products in the kiln chamber, i.e., to apply a temperature to these products in the kiln chamber, the tunnel kiln according to the invention comprises means for heating the kiln chamber. In principle, these means can be any devices for heating the kiln chamber with thermal energy that are known from the prior art for heating the kiln chamber of a tunnel kiln with thermal energy. For example, these means may be electric heating elements or burners, in particular gas burners, in particular radiant tube burners. However, it is particularly preferred that the means for heating the kiln chamber are electric heating elements. This is because it was recognized in accordance with the invention that the undesired horizontal gas flows here can be caused to a certain extent by gas burners, whereas electric heating elements cause no or only negligible gas flows in the horizontal direction in the kiln chamber. According to a preferred embodiment, the tunnel kiln according to the invention has only such electric heating elements for heating the kiln chamber. As is known, electric heating elements are resistance heating elements which heat up due to their electrical resistance when electric current is passed through them. Electrical heating elements in the form of ceramic heating elements are particularly preferred, especially non-oxide ceramic heating elements, in particular ceramic heating elements made of SiC (silicon carbide) or SiN (silicon nitride). It is preferable that the kiln chamber can be heated by the electric heating elements predominantly by convection and less by radiation. The advantage of applying convection heat to the kiln chamber lies in particular in the fact that the products in the kiln chamber can be heated more evenly, as there are essentially no shielding effects. In this respect, it is preferable that the gas in the kiln chamber can be heated by the heating elements in order to heat the kiln chamber by means of the electric heating elements. It is particularly preferable that the gas that can be fed into the kiln chamber through the gas inlets can be heated by the heating elements. In this respect, it is particularly preferable that the gas that can be introduced into the kiln chamber through the gas inlets can be heated by the heating elements before the gas is introduced into the kiln chamber. In this respect, the gas that can be introduced into the kiln chamber is first heated by the heating elements and then introduced into the kiln chamber through the gas inlets. For this purpose, it may be provided that gas is first directed past the heating elements in such a way that the gas is heated and then introduced into the kiln chamber through the gas inlets. According to a particularly preferred embodiment, it may be provided that gas is first conducted past the heating elements by means of the aforementioned gas lines in such a way that the gas is heated and is then introduced into the kiln chamber through the gas inlets. According to a further development of this idea of the invention, it may be provided that gas is discharged from the kiln chamber via the gas outlets, is then conducted past the heating elements in such a way that the gas is heated by them, and is then introduced into the kiln chamber via the gas inlets. As described above, the gas can be directed from the gas outlets to the heating elements via gas lines and then on to the gas inlets. Furthermore, the gas flow can be supported by fans, as described above.

The heated gas introduced into the kiln chamber through the gas inlets can be used to heat the kiln chamber to a desired temperature. In particular, the kiln chamber is heated to the desired temperature for heat treatment of the products in the kiln furniture. The tunnel kiln according to the invention is also particularly suitable for the heat treatment of products at high temperatures, in particular also at at least 300° C. or at least 700° C. In particular, the kiln chamber can be heated to a temperature in the range from 300 to 1,200° C., in the range from 700 to 1,200° C., in the range from 300 to 1,000° C. and particularly preferably in the range from 700 to 1,000° C. Insofar as the tunnel kiln according to the invention is used for the heat treatment of products in the form of cathode material, in particular for the synthesis of cathode material in powder form, it may be provided that the kiln chamber is heated to a temperature in the range from 1,000 to 1,200° C.

According to a particularly preferred embodiment, it is provided that a gas distribution chamber is formed below the kiln furniture. This gas distribution chamber serves in particular to distribute fuel gas evenly below the kiln furniture so that the homogenized gas from the gas distribution chamber can then rise vertically between the kiln furniture. In this way, the products in the kiln furniture can be very evenly supplied with fuel gas and thus with heat. In order to form such a gas distribution space below the kiln furniture, the kiln furniture can preferably rest on spaced-apart supports, with the supports preferably resting on the kiln cars. The supports can preferably be ceramic, in particular refractory ceramic bricks. The gas distribution space is preferably formed between the top of the kiln cars and the kiln furniture.

It is particularly preferable for gas to be introduced into this gas distribution chamber via the gas inlets. Particularly preferably, gas can be introduced into the gas distribution chamber via the above-mentioned gas inlets, via which gas can be introduced into the kiln chamber below the kiln furniture.

The kiln furniture is arranged on the kiln cars with at least one vertical gap between the kiln furniture. These vertical gaps between the kiln furniture allow gases to flow vertically upwards between the kiln furniture up to the kiln roof. Particularly preferably, at least one of the at least one vertical gaps runs between the kiln furniture in the direction of transportation. Preferably, several of the vertical gaps run in the transport direction. According to the invention, it has been recognized that such gaps between the kiln furniture running vertically in the direction of transport not only generate a vertically upwardly directed flow of gases in the kiln chamber, but at the same time can also particularly effectively suppress a gas flow of gases in the kiln chamber in the direction of transport.

In order to form vertical gaps between the kiln furniture, the kiln furniture can be arranged on the kiln cars at a horizontal distance from each other. Particularly preferably, the kiln furniture is arranged on the kiln cars at a distance from one another transversely to the transport direction, forming at least one vertical gap between the kiln furniture, in order to form at least one gap between the kiln furniture in the transport direction.

In addition, vertical gaps can be formed between the kiln furniture transversely to the direction of transportation, for which purpose the kiln furniture can be arranged on the kiln cars at a distance from each other along the direction of transportation, forming at least one vertical gap between the kiln furniture.

According to a particularly preferred embodiment, stackable kiln furniture is provided, in particular kiln furniture that can be stacked on top of one another, particularly preferably kiln furniture that can be stacked vertically on top of one another. According to a particularly preferred embodiment, kiln furniture is provided in the form of cassettes, i.e., in the form of “boxes”, in particular with a rectangular outer contour (when viewed from above). In particular, insofar as the kiln furniture is provided in the form of such cassettes, in particular with a rectangular outer contour, the kiln furniture can be arranged particularly simply and effectively next to one another on the kiln car in such a way that vertically extending gaps can be formed between the kiln furniture.

To transport the products through the kiln chamber, the products are held by the kiln furniture. If products are in the form of powdered products, the powders are held in the kiln furniture, i.e., in the case of kiln furniture in the form of cassettes or boxes, they are held in the cassettes or boxes.

The kiln furniture is preferably made of graphite or ceramic, for example an oxide ceramic or a non-oxide ceramic, particularly preferably a non-oxide ceramic, especially a nitride or carbide non-oxide ceramic, particularly preferably SIC, especially silicate-or ceramic-bonded SiC.

In order to enable the products held in the kiln furniture to be exposed to the hot kiln gases even when the kiln furniture is stacked vertically on top of one another, it may preferably be provided that the kiln furniture is stacked vertically on top of one another in such a way that a flow-through passage is formed between vertically adjacent kiln furniture. If the kiln furniture is designed in the form of cassettes, it may be provided, for example, that these cassettes have closed walls in their lower area so that powdered products can be safely accommodated in the cassettes, and the walls of the cassettes have openings, holes or other apertures in their upper area through which kiln gases can flow between vertically adjacent cassettes.

The kiln cars can be designed according to the state of the art. In this respect, the kiln cars can be moved through the kiln chamber on rails, for example. To move the kiln cars, they can be moved, for example, by means of cable pulls or similar mechanical drive means. The kiln cars can have an essentially rectangular outer contour (in top view).

The kiln cars each have an upper side on which the kiln furniture can be placed. Preferably, the kiln furniture can be placed on the top of the kiln cars. Preferably, the upper side of the kiln cars is designed as a flat surface, preferably with a rectangular outer contour.

Preferably, the upper sides of the kiln cars delimit the kiln chamber on the underside, i.e., form the kiln floor.

The tunnel kiln is preferably sealed gas-tight. Preferably, the tunnel kiln can be formed on the outside by a gas-tight casing, preferably a gas-tight steel housing. It is particularly preferred that the gas-tight steel housing also encloses the kiln cars located in the kiln chamber. In particular, the gas-tight steel housing also encloses the kiln roof, the kiln walls and the kiln cars. Preferably, the gas-tight steel housing extends below the kiln cars so that the kiln cars are also enclosed in a gas-tight manner.

In order to seal the tunnel kiln gas-tight at the first end of the kiln chamber, i.e., at the kiln inlet, and at the second end of the kiln chamber, i.e., at the kiln outlet, sealing means can be provided by which the kiln chamber can be sealed gas-tight, but which allow kiln cars to enter or leave the kiln chamber. Preferably, airlocks can be provided at the first end and second end for this purpose. Appropriate airlocks at the first end and second end of the kiln chamber allow kiln cars to be moved into and out of the kiln chamber while at the same time keeping the kiln chamber permanently enclosed in a gas-tight manner.

The particular advantage of such a gas-tight tunnel kiln is that a desired kiln atmosphere can be set.

An oxidic kiln atmosphere is particularly preferred in the kiln chamber, that is to say the tunnel kiln according to the invention is operated with an oxidic kiln atmosphere. However, it is also possible to operate the tunnel kiln with a reducing kiln atmosphere, for example if graphite kiln furniture is provided.

Preferably, the proportion of oxygen gas in the kiln atmosphere is above 95% by volume. However, it is also possible to operate the kiln with an air atmosphere, Le., with a proportion of oxygen gas of around 21% by volume. If the tunnel kiln is operated with a reducing kiln atmosphere, the kiln can, for example, be operated with nitrogen as the process gas and with a proportion of residual oxygen below 100 ppm.

A particular advantage of the tunnel kiln according to the invention is that it can be made available in practically any length (in the transport direction), in particular also with a length of more than 50 m. According to a preferred embodiment, it is provided that the tunnel kiln has a length of at least 120 m, in particular of at least 150 m. In this respect, the tunnel kiln can have a length in the range of 50 -250 m, for example. Preferably, the tunnel kiln has a length in the range of 120-250 m, even more preferably in the range of 150-250 m and even more preferably in the range of 150-200 m.

Another object of the invention is a method for operating a tunnel kiln, which comprises the following steps:
Provision of a tunnel kiln according to the invention;
Moving the kiln cars along the direction of transportation through the kiln chamber;
Discharging gas present in the kiln chamber via the gas outlets;
Introducing gas into the kiln chamber via the gas inlets; and
Heating the kiln chamber via the heating elements.

Moreover, the method according to the invention may comprise the measures described herein for operating the tunnel kiln according to the invention.

It is also an object of the invention to use a tunnel kiln according to the invention for the heat treatment of products in the form of powder.

Preferably, the tunnel kiln is used for the heat treatment of products in the form of powdered cathode material, in particular for the synthesis of powdered cathode material.

In addition, the tunnel kiln according to the invention can be used in accordance with the measures described herein.

Further features of the invention follow from the claims, the figures and the associated description of the figures.

All features of the invention can be combined with each other, individually or in combination, as desired.

### BRIEF DESCRIPTION OF THE DRAWINGS

One exemplary embodiment of the invention is explained in more detail according to the following description of the figures.

FIG. 1 is a view of a cross-section of an exemplary embodiment of a tunnel kiln according to the invention perpendicular to the longitudinal axis of the tunnel kiln;

FIG. 2 is a view of a section of a cross-section of the tunnel kiln of FIG. 1 parallel to the longitudinal axis; and

FIG. 3 is a view of a cross-section of the tunnel kiln according to FIG. 1 parallel to the longitudinal axis.

### DETAILED DESCRIPTION OF THE INVENTION

The illustrations in the figures are highly schematized with regard to the design and dimensions of the tunnel kiln.

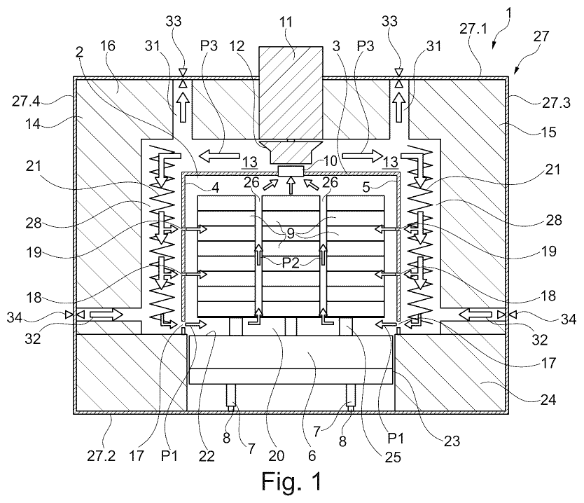

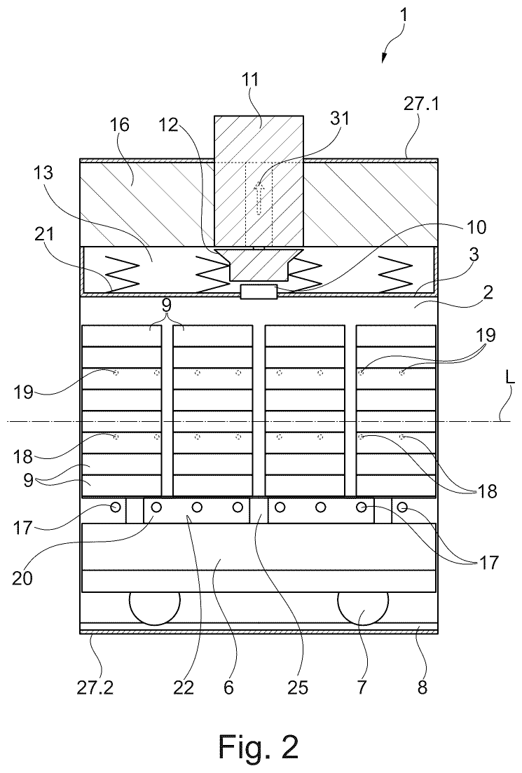

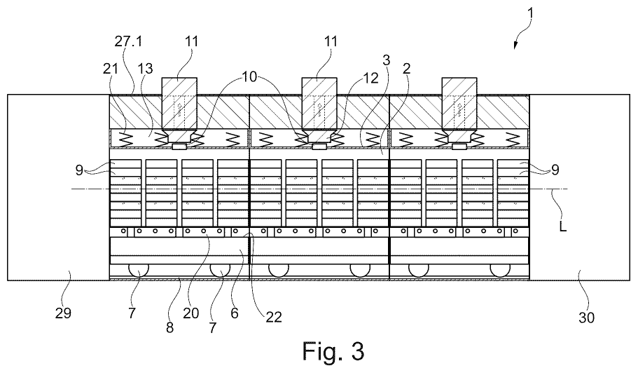

FIG. 1 shows a view of a cross-section of the tunnel kiln perpendicular to the transport direction or longitudinal axis of the tunnel kiln, whereby the tunnel kiln in its entirety is marked with the reference sign 1. The transport direction and longitudinal axis of the tunnel kiln 1 run perpendicular to the plane of the drawing in FIG. 1. The longitudinal axis is labeled L in FIGS. 2 and 3, with the transport direction along the longitudinal axis L running to the right in FIGS. 2 and 3. The tunnel kiln 1 comprises a tunnel-like kiln chamber 2, which extends perpendicular to the drawing plane from a first end (in front of the drawing plane) to a second end (behind the drawing plane) of the kiln chamber 2, the kiln chamber 2 being limited on the top by a kiln ceiling 3 and laterally by a first kiln wall 4, on the left in FIG. 1, and a second kiln wall 5, on the right in FIG. 1. The tunnel kiln 1 also comprises kiln cars 6, which can be moved through the kiln chamber 2 via wheels 7 on rails 8 along the direction of transportation, i.e., perpendicular to the plane of the drawing in FIG. 1 and to the right in FIGS. 2 and 3. Kiln furniture 9 for holding products is arranged on the kiln cars 6.

The kiln ceiling 3 is made of refractory ceramic bricks. Gas outlets 10 in the form of openings passing through the kiln ceiling 3, of which one such gas outlet 10 can be seen in the figures, are arranged evenly spaced apart in the middle of the kiln ceiling 3. The gas outlets 10 are arranged evenly spaced from one another along the direction of transportation on the kiln ceiling 3. The gas outlets 10 lead to a blower 12 driven by a motor 11.

The blower 12 is designed as a fan in the form of a radial fan. The fan 12 comprises an intake nozzle (not shown in detail) and an impeller, both of which have a coating of a nickel-based alloy of the following chemical composition: 90% Ni by mass and 10% Al by mass. The coating has a thickness of 0.5 mm.

The vertical kiln walls 4, 5 are made of refractory ceramic bricks. Gas inlets 17, 18, 19 are provided in the side walls 4, 5 in the form of openings passing through the kiln walls 4, 5. The gas inlets 17, 18, 19 are arranged at different heights on the kiln walls 4, 5, evenly spaced apart along the kiln length in the direction of transportation. In each case, opposing lower gas inlets 17 are arranged on the side walls 4, 5, gas inlets 18 are arranged above them and gas inlets 19 are again arranged above them on the side walls 4, 5. The lowest gas inlets 17 are arranged in such a way that gas can be fed into the kiln chamber 2 below the kiln furniture 9. As explained in more detail below, gas can be introduced via these lowermost gas inlets 17 into a gas distribution chamber 20 formed below the kiln furniture 9, indicated by the arrows P1. Gas can be introduced horizontally into the kiln chamber 2 via the gas inlets 17, 18, 19, whereby gas can be introduced into the kiln chamber 2 at a higher speed via the lower gas inlets 17 than through the gas inlets 18, 19 arranged above.

The refractory ceramic bricks of the kiln roof 6 and the kiln walls 4, 5 are high-alumina bricks with an Al₂O₃ content of over 99% by mass, based on the mass of the bricks.

The tunnel kiln 1 is formed on the outside by a steel housing 27, which seals the tunnel kiln 1 gas-tight to the outside. The steel housing 27 has an essentially rectangular contour with a horizontally extending ceiling 27.1, a horizontally extending base 27.2 and two vertically extending walls 27.3, 27.4. Below the ceiling 27.1 of the steel casing 27, a suspended ceiling 16 made of refractory ceramic bricks is suspended from the ceiling 27.1, which extends above the kiln ceiling 3 at a distance from the latter. This creates a free space 13 above the kiln ceiling 3 between the kiln ceiling 3 and the suspended ceiling 16.

The two walls 27.3, 27.4 of the steel housing 27 are lined on the inside with a cladding of refractory bricks 14, 15, which extends up to the side walls 4, 5 at the level of the side walls 4, 5. The cladding of refractory bricks 14, 15 has vertically extending openings 28, which extend at a distance from each other between the walls 27.3, 27.4 and the side walls 4, 5. The gas inlets 17, 18, 19 each extend through the side walls 4, 5 from the kiln chamber 2 into these openings 28.

The free space 13 and the openings 28 together form gas lines through which gas can be conducted.

Exhaust pipes 31 are routed through the suspended ceiling 16, one end of which opens into the free space 13 and the other into valves 33 in the ceiling 27.1.

Furthermore, fresh gas lines 32 are routed through the linings 14, 15, which open into the openings 28 at one end and into valves 34 in the walls 27.3, 27.4 at the other end.

Vertically arranged electrical heating elements 21 extend from the suspended ceiling 16 through the free space 13 and through the openings 28. The electrical heating elements 21 are ceramic heating elements made of SiC.

The kiln cars 6 are essentially designed according to the state of the art. In this respect, the kiln cars 6 can be moved along the direction of transportation via wheels 7 on rails 8, whereby they can be moved via cable pulls (not shown). The kiln cars 6 have a substantially rectangular outer contour (in top view). The upper side 22 of the kiln cars 6 is designed as a flat surface and delimits the kiln chamber 2 on the underside. On the side, the kiln cars 6 are each sealed against the foundation 24 of the linings 14, 15 of the tunnel kiln 1 by a labyrinth seal 23.

The upper side 22 of the kiln cars 6 serves as a support for the kiln furniture 9. The kiln furniture 9 is placed on the kiln cars 6 via supports 25 in the form of refractory ceramic bricks at a distance from the upper side 22 of the kiln cars 6. This forms the gas distribution chamber 20 between the kiln cars 6 and the kiln furniture 9.

The kiln furniture 9 includes vertically stackable cassettes made of ceramic-bonded SiC. The kiln furniture 9 has a rectangular outer contour (top view). In their lower area, the kiln furniture 9 has closed walls and in their upper area openings so that a passage through which air can flow remains between vertically adjacent, stacked kiln furniture 9.

In the example, eight kiln furniture items 9 are stacked on top of each other. The stacks are each arranged in rows in the direction of transportation on the kiln car 6. Three of these rows are arranged next to each other transversely to the direction of transportation in such a way that a vertical gap 26 remains between the kiln furniture 9 between adjacent rows of kiln furniture 9 stacked on top of each other.

Powdered cathode material is arranged in each of the kiln furniture 9.

At the first, in FIG. 3 left end of the kiln chamber 2, the tunnel kiln 1 has an inlet airlock 29 and at the second, in FIG. 3 right end of the kiln chamber 2, an outlet airlock 30 for gas-tight sealing of the kiln chamber 2 according to the state of the art. The inlet airlock 29 and the outlet airlock 30 allow kiln cars 6 to enter and leave the kiln chamber 2, although the kiln chamber 2 can be sealed gas-tight at the same time.

The tunnel kiln 1 has a length of around 150 m in the direction of transportation.

In practical use, the tunnel kiln 1 shown in the figures is operated as follows:
The kiln cars 6 are pushed into the kiln chamber 2 through the inlet airlock 29, then moved continuously in the transport direction along the longitudinal axis L through the kiln chamber 2 and, after the kiln journey, are moved out of the kiln chamber 2 again through the outlet airlock 30 located at the second end of the kiln chamber 2.

The gas in the kiln chamber 2 is discharged from the kiln chamber 2 via the gas outlets 10. This discharge of gas from the kiln chamber 2 via the gas outlets 10 is assisted by the blower 12 driven by the motor 11, which conveys the kiln gases after discharge from the gas outlets 10 via the intake nozzle and the housing of the blower 12 first into the free space 13 (indicated by the arrows P3), further to the ceramic heating elements 21 and along these, further through the openings 28 and finally through the gas inlets 17, 18, 19 back into the kiln chamber 2. Due to the coating of the intake nozzle and the impeller of the blower 12 with the nickel-based alloy, the kiln gases are effectively prevented from being contaminated by components of the blower 12. The kiln gas is heated as it passes along the ceramic heating elements 21, so that the correspondingly heated gas is then reintroduced into the kiln chamber 2 via the gas inlets 17, 18, 19, indicated by the arrows P1.

The heated gas is introduced into the gas distribution chamber 20 via the lower gas inlets 17 and directed via the gas inlets 18, 19 arranged above towards the respective outer rows of stacked kiln furniture 9, which are adjacent to the side walls 4, 5. The introduced gas is distributed in the gas distribution chamber 20 and then flows vertically upwards through the gaps 26 formed between the kiln furniture 9 (indicated by the arrows P2) to the area of the kiln ceiling 3, where it leaves the kiln chamber 2 again via the gas outlets 10. The gas introduced into the kiln chamber 2 via the gas inlets 18, 19 flows vertically upwards between the outer stacks of kiln furniture 9 and the side walls 4, 5 to the area of the kiln ceiling 3, where it also leaves the kiln chamber 2 via the gas outlets 10. Accordingly, gas is continuously circulated.

The combustion gases can flow essentially vertically upwards in the kiln chamber 2. A flow of the combustion gases in the horizontal and, in particular, in the transport direction can be practically completely avoided.

Parts of the fuel gas circulated in the circuit can be extracted as exhaust gas. For this purpose, fuel gas can be extracted from the free space 13 via the exhaust lines 31, discharged from the kiln 1 by opening the valves 33 and fed to an exhaust gas treatment system. Furthermore, fresh gas can be added to the fuel gas. For this purpose, fresh gas, for example air or oxygen, can be introduced into the fuel gas circuit in the area of the openings 28 by opening the valves 34 via the fresh gas lines 32.

The tunnel kiln 1 is operated with an oxidizing kiln atmosphere, whereby the oxygen concentration in the kiln chamber 2 is above 95% by volume.

The ceramic heating elements 21 are used to heat the kiln chamber in such a way that the temperature in the kiln chamber 2 is around 1,100° C. This allows the powdery cathode material in the kiln furniture 9 to be synthesized.

Due to the flow conditions in the kiln chamber 2 described above, there is no turbulence in the powdered cathode material.

### LIST OF REFERENCE SIGNS

1 Tunnel kiln
2 Kiln chamber
3 Kiln ceiling
4 Left side wall of the kiln chamber
5 Right side wall of the kiln chamber
6 Kiln car
7 Wheels
8 Rails
9 Kiln furniture
10 Gas outlet
11 Motor
12 Blower
13 Free space
14, 15 Side cladding of the steel housing
16 Ceiling cladding of the steel housing
17, 18, 19 Gas inlets
20 Gas distribution chamber
21 Ceramic heating elements
22 Top side of the kiln cars
23 Labyrinth seal
24 Foundation of the side cladding
25 Supports
26 Gap
27 Steel housing
27.1-4 Wall parts of the steel housing
28 Openings
29 Inlet airlock
30 Outlet airlock
31 Exhaust pipes
32 Fresh gas lines
33 Valves of the exhaust pipes
34 Valves of the fresh gas lines
P1-P3 Gas flows

1. A tunnel kiln for heat treatment of products, comprising the following features:
a tunnel-like kiln chamber extending from a first end to a second end of the kiln chamber, the kiln chamber being limited on an upper side by a kiln ceiling and on the side by kiln walls;
kiln cars configured to move from the first end to the second end along a transport direction through the kiln chamber and transport products to be treated with heat in the kiln chamber;
kiln furniture arranged on the kiln cars, the kiln furniture being configured to hold the products;
gas outlets configured to discharge gas present in the kiln chamber, from the kiln chamber;
gas inlets configured to introduce gas into the kiln chamber;
at least one blower configured to conduct gas to the gas inlets; and
means for heating the kiln chamber,
wherein the gas outlets are configured to discharge gas located in the a region of the kiln ceiling from the kiln chamber,
wherein the gas inlets are configured to introduce gas into the chamber in a region of the kiln walls,
wherein the kiln furniture is arranged on the kiln cars with formation of at least one vertical gap between the kiln furniture, and
wherein the at least one blower has a coating made of a nickel-based alloy.

2. The tunnel kiln according to claim 1, wherein the nickel-based alloy comprises a proportion of nickel in the range of 30-99.5%.

3. The tunnel kiln according to claim 1, wherein the nickel-based alloy comprises Ni and at least one component from the group consisting of Al, Mo, and WC.

4. The tunnel kiln according to claim 1, wherein the nickel-based alloy comprises a proportion of Al in the range of 0.5-20.0% and Ni in the range of 80.0-99.5%.

5. The tunnel kiln according to claim 1, wherein the nickel-based alloy comprises a proportion of Mo in the range of 0.5-20.0% and Ni in the range of 80.0-99.5%.

6. The tunnel kiln according to claim 1, wherein the nickel-based alloy comprises a proportion of WC in the range of 0.5-60.0% and Ni in the range of 40.0-99.5%.

7. The tunnel kiln according to claim 1, wherein the coating has a thickness in a range from 0.1 mm to 1.5 mm.

8. The tunnel kiln according to claim 1, wherein the coating is applied by at least one of thermal spraying or baking.

9. The tunnel kiln according to claim 1, wherein the at least one blower is at least one fan.

10. The tunnel kiln according to claim 9, wherein an impeller of the at least one fan has a coating of a nickel-based alloy.

11. The tunnel kiln according to claim 1, wherein the gas discharged from the gas outlets is extracted via the at least one blower.

12. The tunnel kiln according to claim 11, wherein the gas which is extracted from the gas outlets is fed to an intake nozzle of the at least one blower.

13. The tunnel kiln according to claim 12, wherein the intake nozzle has the coating of a nickel-based alloy.

14. A method of operating a tunnel kiln for heat treatment products, the tunnel kiln including a tunnel-like chamber, kiln cars, kiln furniture, gas outlets, gas inlets, at least one blower, and means for heating the kiln chamber, the kiln chamber extending from a first end to a second end of the kiln chamber, the kiln chamber being limited on an upper side by a kiln ceiling and on a lateral side by kiln walls, the kiln cars being configured to move from the first end to the second end along a transport direction through the kiln chamber and transport products to be treated with heat in the kiln chamber, the kiln furniture being arranged on the kiln cars, the kiln furniture being configured to hold the products, the gas outlets being configured to discharge gas present in the kiln chamber from the kiln chamber, the gas inlets being configured to introduce gas into the kiln chamber, the at least one blower being configured to conduct gas to the gas inlets, the method comprising:
moving the kiln cars along the transport direction through the kiln chamber;
discharging gas in the kiln chamber via the gas outlets;
introducing gas into the kiln chamber via the gas inlets; and
heating the kiln chamber via the means for heating the kiln chamber.

15. (canceled)
